(19) United States
(12) Patent Application Publication
(10) Pub. No.: US 2025/0283365 A1
(43) Pub. Date: Sep. 11, 2025

(54) GUIDE SYSTEM FOR GUIDING AT LEAST ONE MOVABLY MOUNTED DOOR LEAF

(71) Applicant: Julius Blum GmbH, Hoechst (AT)

(72) Inventor: Lukas KOHLHAUPT, Lauterach (AT)

(21) Appl. No.: 19/217,442

(22) Filed: May 23, 2025

Related U.S. Application Data
(63) Continuation of application No. PCT/AT2023/060382, filed on Nov. 10, 2023.

(30) Foreign Application Priority Data
Dec. 12, 2022 (AT) A 50949/2022

(51) Int. Cl. E05D 15/58; E06B 3/50

(52) U.S. Cl. CPC E05D 15/58; E06B 3/5045; E05Y 2201/722; E05Y 2600/312

(57) ABSTRACT

A guide system for guiding a movably-supported door wing, includes a carrier for pivotally supporting the door wing, a guide, in particular a guide rail, configured to be fixed to the furniture wall for moving the carrier along the furniture wall, a guide device for displaceably supporting the carrier along the at least one guide, a toothed rack, and a gear engaged or configured to be engaged in the toothed rack. The gear is movable at least partially along the toothed rack upon a movement of the carrier along the guide and being configured to be set into rotation by an engagement in the toothed rack, and the carrier includes a bearing device for supporting the toothed rack.

The present application is a continuation of International Application PCT/AT2023/060382 filed on Nov. 10, 2023. Thus, all of the subject matter of International Application PCT/AT2023/060382 is incorporated herein by reference.

### BACKGROUND OF THE INVENTION

The present invention relates to a guide system for guiding at least one movably-supported door wing, in particular a folding-sliding-door, along a furniture wall, the guide system comprising:
at least one carrier for pivotally supporting the at least one door wing,
at least one guide, in particular a guide rail, configured to be fixed to the furniture wall for moving the at least one carrier along the furniture wall,
at least one guide device for displaceably supporting the at least one carrier along the at least one guide, and
at least one toothed rack and at least one gear engaged or configured to be engaged in the toothed rack, the gear being movable at least partially along the toothed rack upon a movement of the carrier along the guide and being configured to be set into rotation by an engagement in the toothed rack.

Moreover, the invention concerns an item of furniture comprising a furniture carcass, at least one door wing, in particular a folding-sliding-door, movably supported relative to the furniture carcass, and at least one guide system of the type to be described for moving the at least one door wing relative to the furniture carcass.

US 2004/046488 A1 discloses a guide system for a door wing which is movable along a sidewall of the furniture carcass by the guide system. The door wing is thus insertable in a depth direction of the item of furniture, and the door wing reveals access to the interior of the furniture carcass in the inserted condition. The door wing is pivotally supported on a carrier via hinges. The carrier is movable along the sidewall of the furniture carcass via a plurality of toothed racks and via a plurality of gears engaging in the toothed racks, the toothed racks being spaced apart from each other in a height direction. By a synchronization shaft, the rotational movements of the gears can be synchronized with each other. A drawback of this construction is that the guide system is only suitable for door wings having a low weight. The challenge when guiding a door wing along a furniture wall is, in fact, that the door wing has a tendency to tilt due to its weight. This, in turn, leads to an undesired torsional movement of the carrier and to a jamming of the door wing relative to the guide. Moreover, it is possible that the upper gears no longer duly engage in their associated upper toothed racks, whereas the lower gears can get jammed with the lower toothed rack due to the occurring weight of the door wing. These circumstances lead to the fact that a movement of the door wing is made impossible or is at least substantially impeded. Moreover, undesired operating noises can occur, especially because all toothed racks are flatly fixed to the sidewall. In this way, it is possible that the furniture carcass becomes a resonator body due to the occurring oscillations, and the noises are additionally increased therewith.

### SUMMARY OF THE INVENTION

It is an object of the present invention to propose a guide system of the type mentioned in the introductory part, thereby avoiding the drawbacks as discussed above.

According to the invention, the at least one carrier includes at least one bearing device for supporting the at least one toothed rack.

In other words, the at least one toothed rack is supported on the carrier on which the at least one door wing is to be pivotally arranged, the carrier being movable in the mounted position along at least one guide arranged on the furniture wall. In this way, it can be ensured that the at least one gear has a defined spacing with respect to the at least one toothed rack, and the gear is always movable relative to the toothed rack with a predefined engagement depth. Moreover, disturbing operating noises can be thereby reduced.

According to an embodiment, the at least one bearing device and the at least one toothed rack are movable relative to each other, preferably displaceable relative to each other.

According to a preferred embodiment, the at least one bearing device includes at least one linear guide, preferably a U-shaped profile, for movably supporting, preferably displaceably supporting, the at least one toothed rack.

Due to the at least one linear guide, the engagement depth of the at least one gear can be limited such that the teeth of the at least one gear only partially engage in the teeth spaces of the at least one toothed rack. In this way, the engagement depth of the at least one gear can be limited such that a jamming or a disengagement of the at least one gear with respect to the at least one toothed rack is prevented.

### BRIEF DESCRIPTION OF THE DRAWINGS

Further details and advantages of the present invention will be apparent from the following description of figures, in which:

FIG. 1a, 1b are a perspective view of an item of furniture comprising a furniture carcass and door wings movable relative thereto,

FIG. 2a, 2b show the item of furniture according to FIGS. 1a, 1b in further positions of the door wings relative to each other,

FIG. 3 is a perspective view of a furniture wall with the guide system,

FIG. 4 is a further perspective view of a furniture wall with the guide system,

FIG. 5a-5c are enlarged detail views according to FIG. 4,

FIG. 6 shows the guide system in a perspective view,

FIG. 7a, 7b show the guide system in a perspective view from the front and an enlarged detail view thereof,

FIG. 8a, 8b are a perspective view of a bearing device with a toothed rack supported thereon, and an enlarged detail view thereof,

FIG. 9 is a side view of the furniture wall with a door wing fully extended, and

FIG. 10a, 10b shows the (upper) first bearing device and the (lower) second bearing device in engagement with the (upper) first toothed rack and the (lower) second toothed rack.

### DETAILED DESCRIPTION OF THE INVENTION

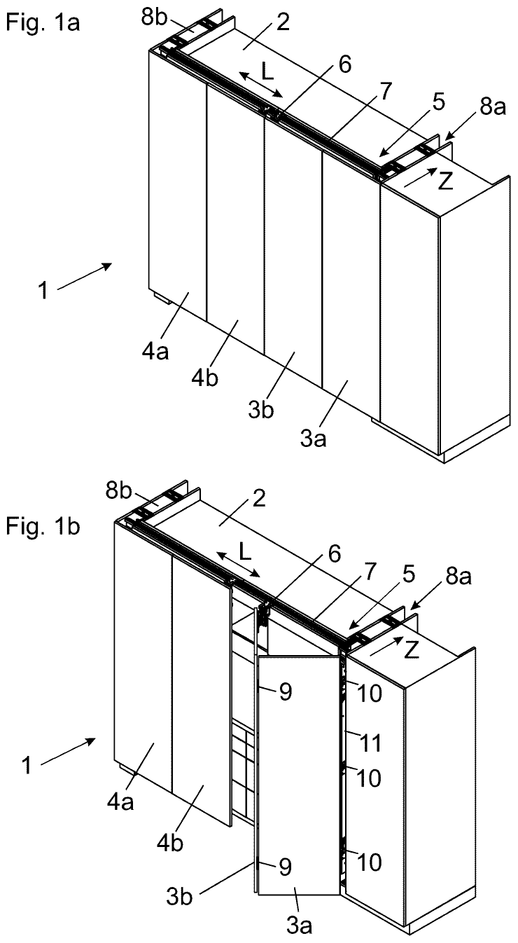

FIG. 1a shows a perspective view of an item of furniture 1 comprising a furniture carcass 2 and door wings 3a, 3b; 4a, 4b movable relative to the furniture carcass 2. The door wings 3a, 3b and the door wings 4a, 4b are movable by a guide system 5 between a first position, in which the door wings 3a, 3b; 4a, 4b are aligned substantially coplanar to each other, and a second position, in which the door wings 3a, 3b; 4a, 4b are aligned substantially parallel to each other.

The door wings 3a, 3b are insertable into a lateral receiving compartment 8a of the furniture carcass 2 when located in the second (parallel) position, whereas the door wings 4a, 4b are insertable into a further receiving compartment 8b when located in a parallel position to each other.

The functionality will be explained in the following with the aid of the door wings 3a and 3b, and the same explanations are valid for the door wings 4a, 4b.

The guide system 5 includes a guide rail 7 having a longitudinal direction (L), and a guide carriage 6 configured to be connected to the second door wing 3b is displaceably supported along the guide rail 7. In a mounted condition, the guide rail 7 extends substantially parallel to the front face of the furniture carcass 2.

FIG. 1b shows the item of furniture 1, in which the door wings 3a, 3b have been moved from the coplanar position shown in FIG. 1a into an angled position relative to each other. The first door wing 3a is pivotally supported on a carrier 11 via two or more hinges 10, and the carrier 11 (jointly with the door wings 3a, 3b) is insertable in a depth direction (Z) into the lateral receiving compartment 8a.

In FIG. 1b, the carrier 11 is located in a transfer position in which the carrier 11 adjoins the guide rail 7 in the longitudinal direction (L) such that the guide carriage 6 is transferable to and from between the guide rail 7 and the carrier 11. In the shown transfer position, the carrier 11 is releasably locked to the guide rail 7, and the locking between the guide rail 7 and the carrier 11 is releasable by an entry of the running carriage 6 in or onto the carrier 11.

The carrier 11 is in the form of a longitudinally extending column, and the length of which is at least half of a height of the door wings 3a, 3b. The two door wings 3a, 3b are hingedly connected to each other about a vertically extending axis via at least one hinge fitting 9. The second door wing 3b is displaceably supported along the guide rail 7 via the guide carriage 6.

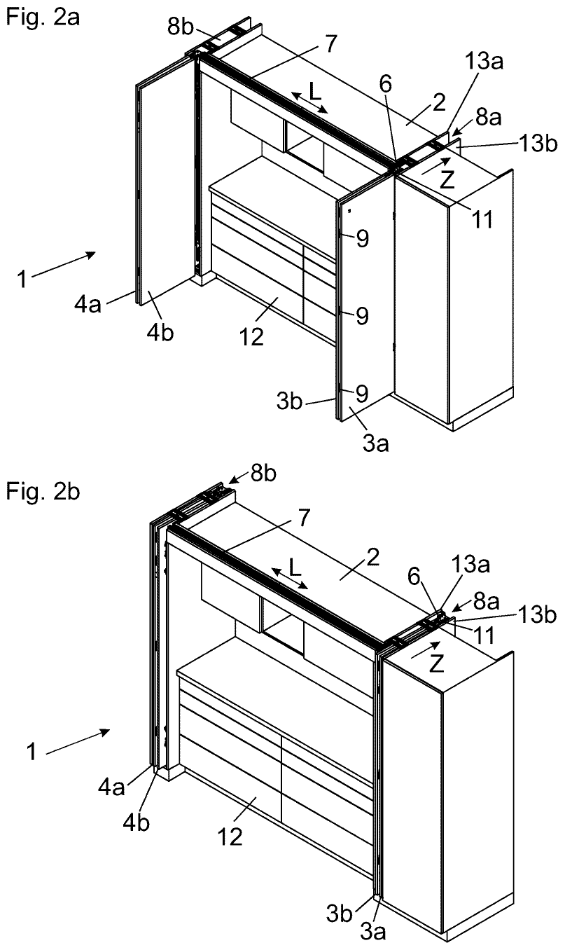

FIG. 2a shows the item of furniture 1 with the door wings 3a and 3b which are now aligned parallel to each other. The carrier 11 has been unlocked from the guide rail 7 by an entry of the guide carriage 6, and the carrier 11 (jointly with the guide carriage 6 and the door wings 3a, 3b) is insertable in a depth direction (Z) of the furniture carcass 2 into the receiving compartment 8a. The depth direction (Z) extends transversely, preferably substantially perpendicular, to the longitudinal direction (L) of the guide rail 7.

FIG. 2b shows the item of furniture 1 with the door wings 3a, 3b which are now located in a fully inserted condition within the receiving compartment 8a. The door wings 3a, 3b are thus movable by the guide system 5 between a first position according to FIG. 1a, in which the door wings 3a, 3b are aligned substantially coplanar to each other, and a second position according to FIG. 2b, in which the door wings 3a, 3b are aligned substantially parallel to each other and being received within the receiving compartment 8a.

In this way, for example a kitchen 12, as shown in FIG. 2a, 2b, can be entirely covered so as to separate the kitchen 12 from a remaining area of a living room.

In the shown embodiment, the receiving compartment 8a is formed by a first furniture wall 13a and by a second furniture wall 13b spaced apart from the first furniture wall 13a in a substantially parallel relationship. The door wings 3a, 3b, in a parallel position to each other, are insertable between the two furniture walls 13a, 13b. In the shown embodiment, each of the two furniture walls 13a, 13b are configured as sidewalls of the furniture carcass 2.

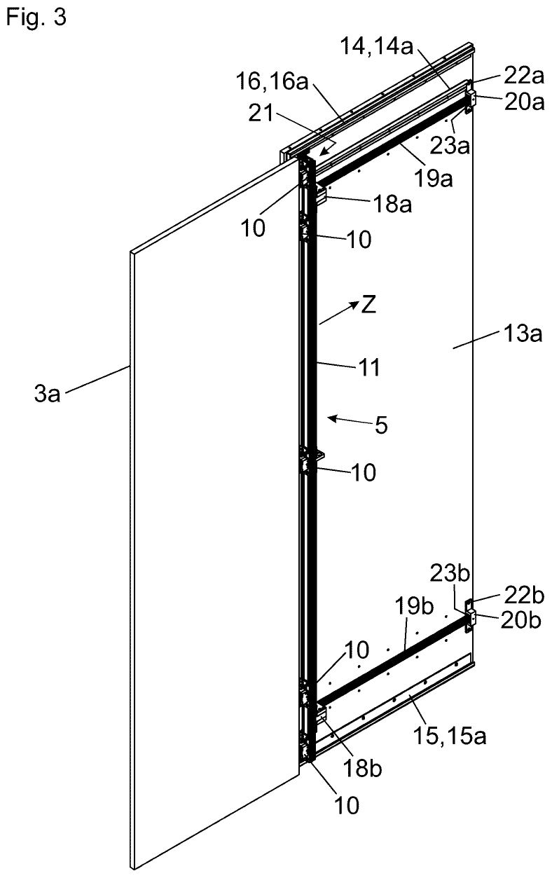

FIG. 3 shows a perspective view of the furniture wall 13a with the guide system 5 for guiding the at least one door wing 3a. For the sake of improved overview, the second door wing 3b hingedly connected to the first door wing 3a is not illustrated.

The guide system 5 includes at least one longitudinally extending carrier 11 on which the at least one door wing 3a can be pivotally supported, for example via two or more hinges 10. The carrier 11 can have a length corresponding substantially to a height of the door wing 3a.

The guide system 5 includes at least one guide 14, preferably a guide rail 14a, configured to be fixed to the furniture wall 13a, the guide 14 being provided for moving the at least one carrier 11 along the furniture wall 13a.

In the shown embodiment, further guides 15, 16, preferably further guide rails 15a, 16a, are provided by which the at least one carrier 11 is displaceable along the furniture wall 13a. The guides 14, 15, 16 are fixed to the furniture wall 13a with a vertical distance from each other.

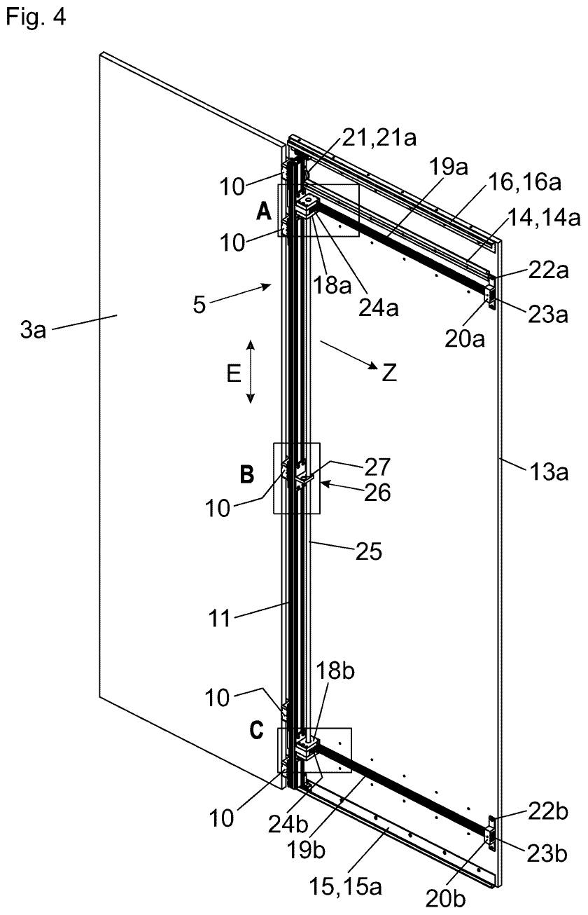

The carrier 11 is displaceable along the at least one guide 14 via at least one guide device 21. The guide device 21 can include at least one running wheel 21a (FIG. 4), preferably a plurality of running wheels 21a, configured to run along the at least one guide 14.

The guide device 21 can include a plurality of running wheels 21a rotationally supported about a rotational axis oriented in a first direction. Moreover, further running wheels rotationally supported about a rotational axis oriented in a second direction can be provided.

The guide system 5 includes at least one toothed rack 19a, and at least one gear 24a (FIG. 4) is displaceable on the at least one toothed rack 19a upon a movement of the carrier 11 along the at least one guide 14.

In the shown embodiment, at least one second toothed rack 19b is provided, and at least one second gear 24b (FIG. 4) is displaceable along the second toothed rack 19b upon a movement of the carrier 11 along the guides 14, 15, 16.

According to the invention, the carrier 11 includes at least one bearing device 18a, 18b for supporting the at least one toothed rack 19a, 19b.

The toothed rack 19a, 19b has an end section, and at least one holding device 20a, 20b configured to be fixed to the furniture wall 13a is provided for supporting the end section of the toothed rack 19a, 19b.

The holding device 20a, 20b includes at least one fastening location 22a, 22b for fixing an end section of the toothed rack 19a, 19b to the furniture wall 13a. For example, the fastening location 22a, 22b of the holding device 20a, 20b can include a hole for the passage of a screw and/or at least one dowel to be fixed to the furniture wall 13a.

Each of the holding devices 20a, 20b includes a guide 23a, 23b for movably supporting the toothed rack 19a, 19b. In other words, the toothed rack 19a, 19b is displaceably supported relative to the holding device 20a, 20b.

For example, the at least one gear 24a, 24b (FIG. 4) configured to run along the toothed rack 19a, 19b can be rotationally arranged on the carrier 11 or on the at least one bearing device 18a, 18b of the carrier 11.

FIG. 4 shows a further perspective view of the furniture wall 13a with the guide system 5 according to FIG. 3. The two bearing devices 18a, 18b of the carrier 11 can be seen, and at least one gear 24a, 24b is rotationally supported on each or in each of the bearing devices 18a, 18b or on the carrier 11. The at least one gear 24a, 24b can be rotationally supported about an axis extending parallel to the longitudinal direction (E) of the carrier 11, and is configured so as to mesh with the at least one toothed rack 19a, 19b.

For synchronizing a rotational movement of the gears 24a, 24b, at least one synchronization shaft 25 is provided, the synchronization shaft 25 extending substantially parallel to the longitudinal direction (E) of the carrier 11. As a result, a rotational movement of the gears 24a, 24b can be synchronized with each other by a rotational movement of the synchronization shaft 25 about its own axis.

In the shown embodiment, at least one stabilizing device 26 is provided, the stabilizing device 26 being configured to prevent or at least to limit a bulging movement of the synchronization shaft 25 in a direction extending transversely to the longitudinal direction (E) of the synchronization shaft 25.

The at least one stabilizing device 26 can be arranged in a central region of the synchronization shaft 25 and/or can include at least one opening 27 for the passage of the synchronization shaft 25.

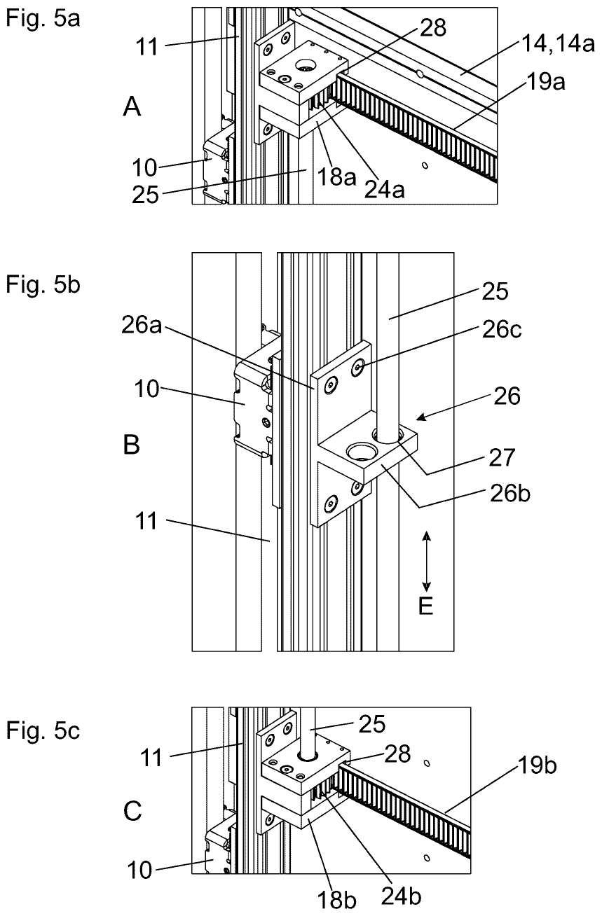

FIGS. 5a-5c each show an enlarged detail view of FIG. 4.

FIG. 5a shows the framed region “A” according to FIG. 4 in an enlarged view. To be seen is the bearing device 18a for movably supporting the toothed rack 19a, the bearing device 18a being fixed to the carrier 11. The bearing device 18a includes at least one rotatable gear 24a meshing with the toothed rack 19a.

The bearing device 18a can include at least one linear guide 28 for movably supporting the toothed rack 19a. The bearing device 18a is movably supported relative to the toothed rack 19a upon a movement of the carrier 11 along the guide 14. In the shown embodiment, the at least one guide 28 includes a U-shaped profile in which the toothed rack 19a can be guided.

FIG. 5b shows the framed region “B” according to FIG. 4 in an enlarged view. The stabilizing device 26 can be seen, the stabilizing device 26 being configured to prevent or at least to limit a bulging movement of the synchronization shaft 25 in a direction extending transversely to the longitudinal direction (E) of the synchronization shaft 25.

In the shown embodiment, the stabilizing device 26 includes a fastening section 26a configured to bear against the carrier 11, and further includes a holding limb 26b for holding the synchronization shaft 25. The holding limb 26b projects transversely, preferably perpendicular, from the fastening section 26a. The fastening section 26a includes at least one fastening location 26c for fixing the stabilizing device 26 to the carrier 11. The holding limb 26b includes at least one, for example cylindrical, opening 27 for the passage of the synchronization shaft 25.

FIG. 5c shows the framed region “C” according to FIG. 4 in an enlarged view. The lower, second bearing device 18b includes at least one second gear 24b configured to run along the second toothed rack 19b. The rotational movements of the two gears 24a, 24b can be synchronized with each other via the at least one synchronization shaft 25. The second bearing device 18b also includes a linear guide 28, preferably a U-shaped profile, configured to receive and to guide the second toothed rack 19b.

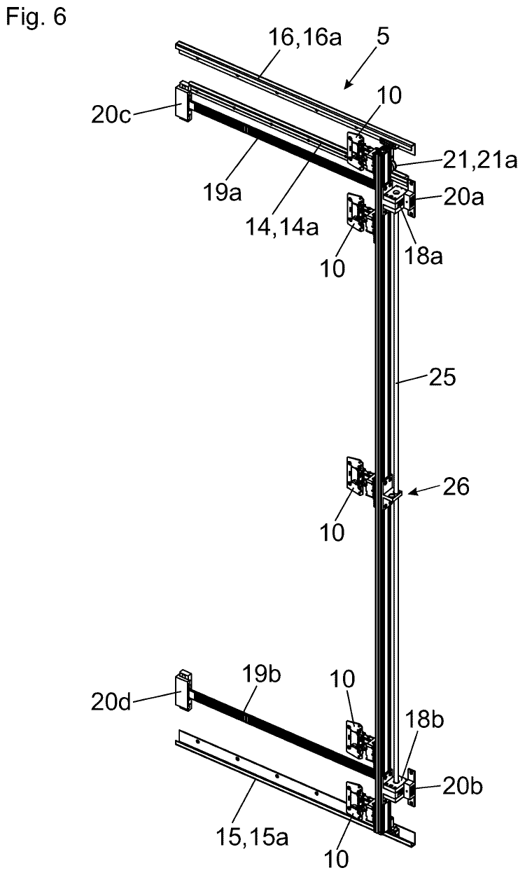

FIG. 6 shows the guide system 5 in a further perspective view. In FIG. 6, the guide system 5 is located in a position in which the door wing 3a is entirely located within the receiving compartment 8a (corresponding to the position according to FIG. 2b). For reasons of improved overview, the door wing 3a is not depicted.

Each of the toothed racks 19a, 19b includes a first end section and a second end section. The first end section of the toothed rack 19a, 19b is supported on a first holding device 20a, 20b, and the second end section of the toothed rack 19a, 19b is supported on a second holding device 20c, 20d. Each of the holding devices 20a, 20b, 20c, 20d is to be fixed to the furniture wall 13a, and the bearing device 18a, 18b is movable between the two holding devices 20a, 20b, 20c, 20d.

In other words, each of the end sections of the toothed racks 19a, 19b are supported on a holding device 20a, 20b, 20c, 20d, and each of the holding devices 20a, 20b, 20c, 20d is to be fixed to the furniture wall 13a.

Preferably, the holding devices 20a, 20b, 20c, 20d are configured to hold the at least one toothed rack 19a, 19b with a distance to the furniture wall 13a in a fixed condition of the holding device 20a, 20b, 20c, 20d.

The bearing device 18a, 18b is thus movable between the holding devices 20a, 20b, 20c, 20d, and the toothed rack 19a, 19b is spaced apart from the furniture wall 13a. As a result, the relative spacing between the gear 24a, 24b and the toothed rack 19a, 19b can be maintained in a constant manner, so that the gear 24a, 24b is always movable with a constant engagement depth along the toothed racks 19a, 19b.

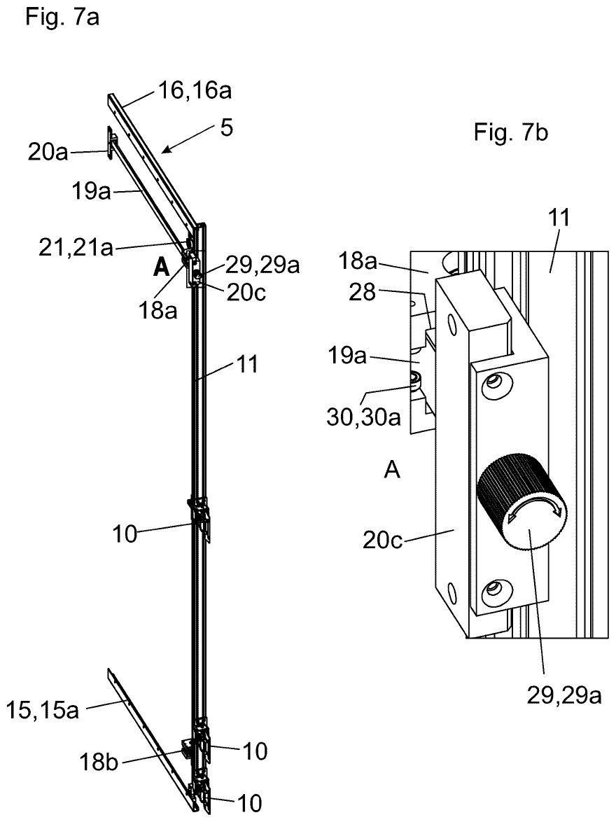

FIG. 7a shows the guide system 5 in a perspective view from the front. The guides 15, 16, preferably in the form of guide rails 15a, 16a, can be seen, the carrier 11 with the hinges 10 for movably supporting the door wing 3a being movable along the guides 15, 16 in a mounted position.

One end of the toothed rack 19a is to be fixed to the furniture wall 13a via the holding device 20a. The other end of the toothed rack 19a is also to be fixed to the furniture wall 13a via the holding device 20c (FIG. 6). The bearing device 18a of the carrier 11 is movable along the toothed rack 19a between the two holding devices 20a, 20c.

For compensating for a malposition between the (upper) first toothed rack 19a and the (lower) second toothed rack 19b, at least one adjustment device 29 is provided. By the adjustment device 29, a position of the toothed rack 19a relative to the at least one holding device 20a, 20c is adjustable.

For example, the adjustment device 29 can include at least one rotatable adjustment wheel 29a, and a position of the toothed rack 19a relative to the holding device 18a is adjustable by rotating the at least one adjustment wheel 29a.

As a result, a malposition, in particular a tilting movement, of the at least one door wing 3a can be corrected by the adjustment device 29. The malposition is caused by a torsional movement of the carrier 11 and/or by a weight of the door wing 3a.

In other words, the position of the carrier 11 relative to the toothed rack 19a is adjustable by the adjustment device 29, and a movability between the toothed rack 19a and the holding devices 20a, 20c to be fixed to the furniture wall 13a has to be permitted.

According to an embodiment, the front end of the toothed rack 19a is connected to the adjustment element 29a of the holding device 20c in a movement-coupled manner. In contrast, the rear end of the toothed rack 19a is glidingly guided in the guide 23a (FIG. 4) of the holding device 20a.

FIG. 7b shows the framed region “A” of FIG. 7a in an enlarged view. The adjustment wheel 29a is rotationally supported on the frontal holding device 20c. By rotating the adjustment wheel 29a, a position of the toothed rack 19a relative to the holding devices 20a, 20c is adjustable. To be seen is the linear guide 28 of the bearing device 18a for movably supporting the toothed rack 19a.

At least one gliding device 30 can be provided, the gliding device 30 being configured to reduce a frictional resistance between the at least one bearing device 18a, 18b and the at least one toothed rack 19a, 19b. For example, the at least one gliding device 30 can include a rolling body 30a rotatable about an axis, preferably about a vertically extending axis in the mounted position.

Due to the tilting movement of the at least one door wing 3a caused by the weight, it is possible that a side of the toothed rack 19a, opposing the side having the provided teeth, is pressed against the bearing device 18a. For this reason, the gliding device 30 for reducing the frictional resistance between the toothed rack 19a and the bearing device 18a is provided.

The at least one adjustment wheel 29a of the adjustment device 29 can be configured for manual actuation and/or is directly accessible for a person from the front in a mounted condition of the guide system 5.

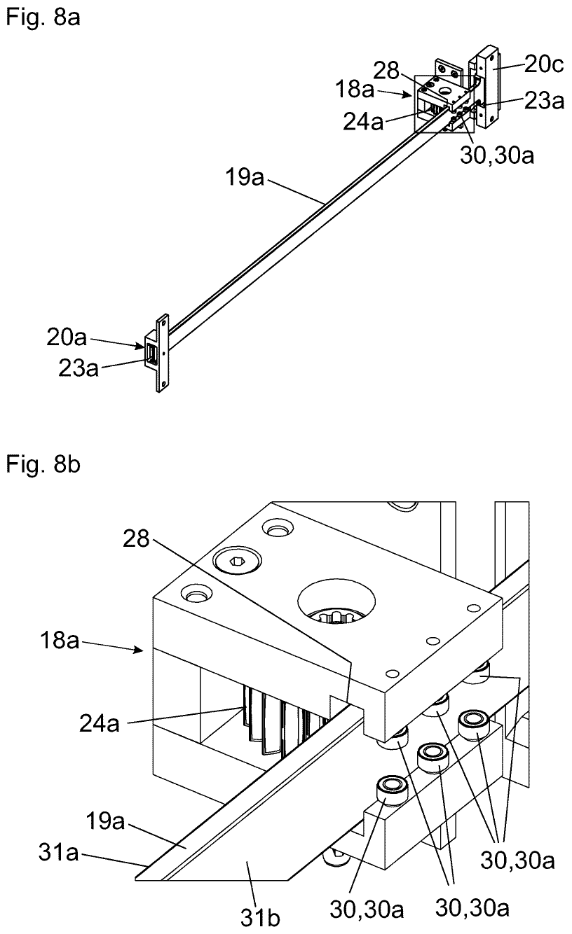

FIG. 8a shows a perspective view of the toothed rack 19a with the two holding devices 20a, 20c to be fixed to the furniture wall 13a, and with the bearing device 18a for movably supporting along the toothed rack 19a.

Each of the holding devices 20a, 20c to be fixed to the furniture wall 13a includes a guide 23a for movably supporting the toothed rack 19a.

FIG. 8b shows the framed region of FIG. 8a in an enlarged view. At least one gear 24a is rotationally supported on the bearing device 18a, the gear 24a being movable along the toothed rack 19a.

The at least one toothed rack 19a has a first longitudinal side 31a having teeth which are in engagement or which can be brought in engagement with the at least one gear 24a. The toothed rack 19a further includes a second longitudinal side 31b opposing the first longitudinal side 31a, and the at least one gliding device 30 is configured to bear against the second longitudinal side 31b of the toothed rack 19a.

The gliding device 30 for reducing the frictional resistance between the toothed rack 19a and the bearing device 18a can include at least one rolling body 30a configured to bear against the second longitudinal side 31b of the toothed rack 19a.

In the shown embodiment, the gliding device 30 includes a plurality of rolling bodies 30a which are spaced apart from each other in a longitudinal direction of the toothed rack 19a and/or which are arranged in at least two running planes arranged above each other in a mounting position.

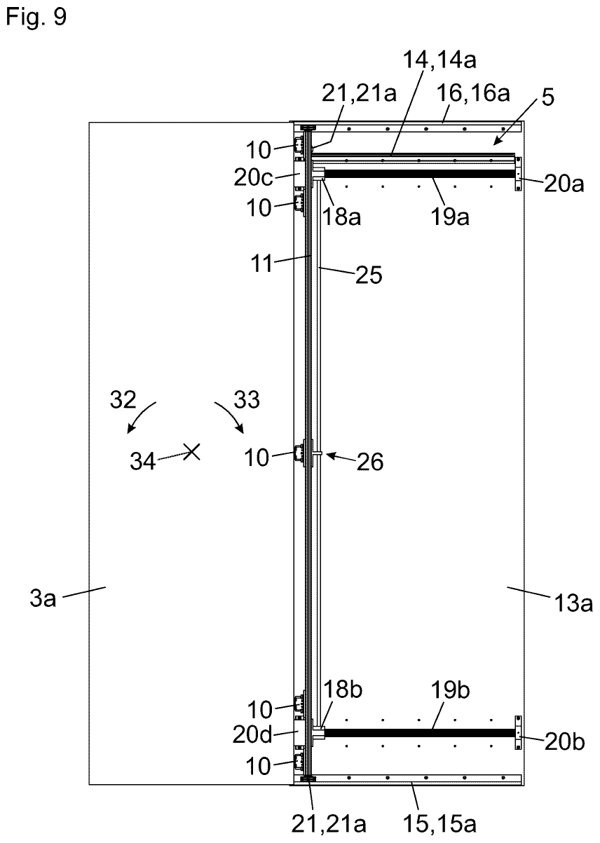

FIG. 9 shows a side view of the furniture wall 13a with the door wing 3a fully extended. The arrangement consisting of toothed racks 19a, 19b, gears 24a, 24b, bearing devices 18a, 18b and, if appropriate, the synchronization shaft 25, collectively form a compensating device for compensating for a tilting moment 32 of the carrier 11 or of the door wing 3a arranged thereon about a tilting axis 34 by a return moment 33.

When the carrier 11 or the door wing 3a is vertically aligned, the tilting axis 34 is horizontally aligned. The compensating device with the aforementioned components thus ensures that the at least one door wing 3a is stably guided in each position, thereby preventing an undue tilting movement of the door wing 3a relative to the guides 14, 15, 16.

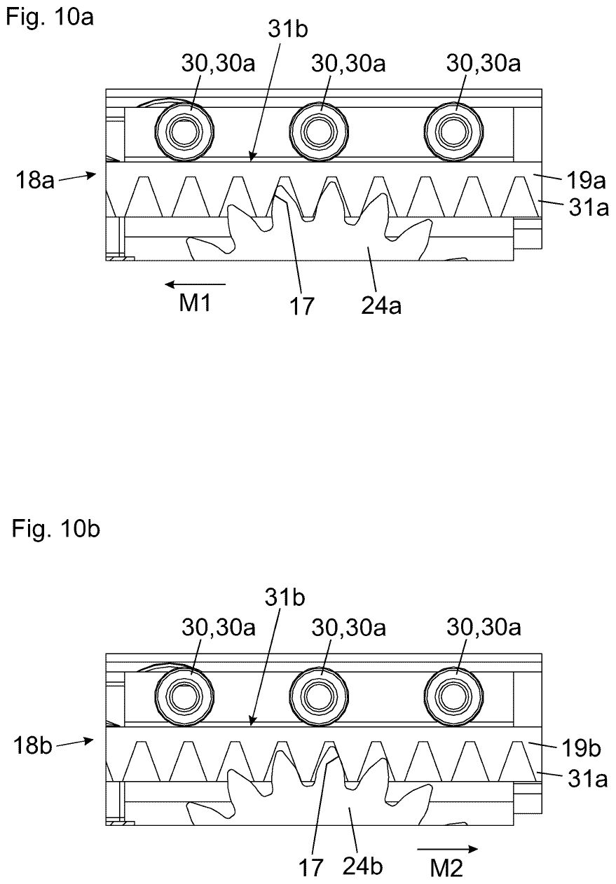

FIG. 10a shows the (upper) first bearing device 18a in engagement with the (upper) first toothed rack 19a. The gear 24a is rotationally supported on the bearing device 18a. The bearing device 18a is arranged on the carrier 11, and the door wing 3a is pivotally supported on the carrier 11 via the hinges 10. This means that the gear 24a is pulled in the direction M1 by the weight of the door wing 3a. The tooth flank 17 of the gear 24a is thus pressed against the teeth of the toothed rack 19a in the direction M1. Due to the co-operation of the oblique tooth flank 17 of the gear 24a with the oblique toothing of the toothed rack 19a, a resulting force presses the second longitudinal side 31b (see FIG. 8b), opposing the first longitudinal side 31a, against the gliding device 30 having the rolling bodies 30a. Accordingly, the gliding device 30 is thus provided to reduce the frictional resistance between the second longitudinal side 31b of the toothed rack 19a and the upper bearing device 18a.

FIG. 10b, in contrast, shows the (lower) second bearing device 18b in engagement with the (lower) second toothed rack 19b. The second gear 24b is rotationally supported on the second bearing device 18b. The second bearing device 18b is arranged on the carrier 11 so as to be spaced apart from the first bearing device 18a, and the door wing 3a is pivotally supported on the carrier 11 via the hinges 10. This means that the second gear 24b of the (lower) second bearing device 18b is pressed in the direction M2 by the weight of the door wing 3a. The tooth flank 17 of the second gear 24b is thus pressed against the teeth of the second toothed rack 19b in the direction M2. Due to the co-operation of the oblique tooth flank 17 of the second gear 24b with the oblique toothing of the second toothed rack 19b, a resulting force presses the second longitudinal side 31b, opposing the first longitudinal side 31a, of the second toothed rack 19b against the second gliding device 30 having the rolling bodies 30a. Accordingly, the second gliding device 30 is thus provided to reduce the frictional resistance between the second longitudinal side 31b of the second toothed rack 19b and the (lower) second bearing device 18b.

1. A guide system for guiding at least one movably-supported door wing, in particular a folding-sliding-door, along a furniture wall, the guide system comprising:
at least one carrier for pivotally supporting the at least one door wing,
at least one guide, in particular a guide rail, configured to be fixed to the furniture wall for moving the at least one carrier along the furniture wall,
at least one guide device for displaceably supporting the at least one carrier along the at least one guide, and
at least one toothed rack and at least one gear engaged or configured to be engaged in the toothed rack, the gear being movable at least partially along the toothed rack upon a movement of the carrier along the guide and being configured to be set into rotation by an engagement in the toothed rack,
wherein the at least one carrier includes at least one bearing device for supporting the at least one toothed rack.

2. The guide system according to claim 1, wherein the at least one bearing device and the at least one toothed rack are movable relative to each other, preferably displaceable relative to each other, and/or wherein the at least one bearing device includes at least one linear guide, preferably a U-shaped profile, for movably, preferably displaceably, supporting the at least one toothed rack.

3. The guide system according to claim 1, wherein the at least one toothed rack has an end section, and at least one holding device to be fixed to the furniture wall is provided on which the end section of the toothed rack is supported.

4. The guide system according to claim 3, wherein the at least one toothed rack and the at least one holding device are movable relative to each other, preferably displaceable relative to each other, preferably wherein the at least one holding device includes at least one guide for movably supporting the at least one toothed rack.

5. The guide system according to claim 3, wherein at least one adjustment device is provided for adjusting a position of the at least one toothed rack relative to the at least one holding device, preferably wherein the at least one adjustment device includes at least one rotatable adjustment wheel, and a position of the at least one toothed rack relative to the at least one holding device is adjustable by rotating the at least one adjustment wheel.

6. The guide system according to claim 3, wherein the at least one holding device is configured so as to hold the at least one toothed rack with a distance to the furniture wall in a fixed condition of the holding device.

7. The guide system according to claim 3, wherein the at least one toothed rack has a first end section and a second end section, wherein the first end section of the toothed rack is supported on a first holding device and the second end section of the toothed rack is supported on a second holding device, wherein each of the holding devices is to be fixed to the furniture wall and the bearing device is movable between the two holding devices.

8. The guide system according to claim 1, wherein the at least one gear is rotationally supported on the at least one bearing device or on the at least one carrier.

9. The guide system according to claim 1, wherein at least one gliding device is provided for reducing a frictional resistance between the at least one bearing device and the at least one toothed rack, preferably wherein the at least one gliding device is arranged on the bearing device.

10. The guide system according claim 9, wherein the at least one toothed rack includes a first longitudinal side having teeth, the first longitudinal side being configured to be engaged with the at least one gear, and further includes a second longitudinal side opposing the first longitudinal side, wherein the at least one gliding device is configured to bear against the second longitudinal side of the at least one toothed rack.

11. The guide system according claim 9, wherein the at least one gliding device includes at least one rolling body rotatable about an axis, preferably extending vertically in the mounted position, preferably wherein the gliding device includes a plurality of rolling bodies spaced apart from each other in a longitudinal direction of the at least one toothed rack and/or arranged in at least two running planes lying above each other in the mounted position.

12. The guide system according to claim 1, wherein at least a second toothed rack is provided and the carrier includes a second bearing device for supporting the second toothed rack, wherein the second bearing device is spaced apart from the bearing device in a longitudinal direction of the carrier, wherein at least a second gear is provided which engages or which is configured to be engaged in the second toothed rack, the second gear being movable at least partially along the second toothed rack upon a movement of the carrier along the at least one guide and being configured to be set into rotation by an engagement in the second toothed rack.

13. The guide system according claim 12, wherein the guide system includes at least one synchronization shaft for synchronizing a movement of the two gears.

14. The guide system according claim 13, wherein the guide system includes at least one stabilizing device configured to prevent or at least to limit a bulging movement of the synchronization shaft in a direction extending transversely to a longitudinal direction of the synchronization shaft, preferably wherein the at least one stabilizing device:
is arranged in a central region of the synchronization shaft, and/or
includes at least one opening for the passage of the synchronization shaft, and/or
includes a fastening section configured to bear against the carrier and a holding limb for holding the synchronization shaft, the holding limb projecting transversely, preferably perpendicular, from the fastening section, wherein the fastening section includes at least one fastening location for fixing to the carrier.

15. The guide system according to claim 12, wherein the arrangement consisting of toothed racks, gears, bearing devices and, if appropriate, synchronization shaft for synchronizing a movement of the gears, collectively form a compensating device for compensating for a tilting moment of the carrier or of the door wing arranged thereon about a tilting axis by a return moment.

16. The guide system according to claim 1, wherein the guide system includes at least a second guide, preferably a guide rail, to be fixed to the furniture wall with a vertical distance to the at least one guide, wherein at least one further guide device is provided for displaceably supporting the at least one carrier along the second guide.

17. The guide system according to claim 1, wherein the guide device includes at least one running wheel, preferably a plurality of running wheels, wherein the at least one running wheel is displaceable along the at least one guide, preferably wherein a plurality of running wheels is rotationally supported about a rotational axis oriented in a first direction, and further running wheels are rotationally supported about a rotational axis oriented in a second direction.

18. An item of furniture comprising a furniture carcass, at least one door wing, in particular a folding-sliding-door, movably supported relative to the furniture carcass, and at least one guide system according to claim 1 for moving the at least one door wing relative to the furniture carcass, preferably wherein the furniture carcass includes at least one furniture wall in the form of a sidewall, wherein the at least one guide, in particular a guide rail, is fixed to the sidewall and wherein the at least one door wing is movable by the guide system along the sidewall of the furniture carcass.
